(19) United States
(12) Patent Application Publication
(10) Pub. No.: US 2007/0187857 A1
(43) Pub. Date: Aug. 16, 2007

(54) Methods for making and using composites, polymer scaffolds, and composite scaffolds

(76) Inventors: Susan Lynn Riley, San Diego, CA (US); Joseph Tai, San Diego, CA (US); Rhiannon Dabkowski, San Diego, CA (US); Rodney Moser, San Diego, CA (US); Marc H. Hedrick, Encintas, CA (US); Timothy Alexander Moseley, Solara Beach, CA (US)

Correspondence Address: STOUT, UXA, BUYAN & MULLINS LLP, 4 VENTURE, SUITE 300, IRVINE, CA, 92618, US

(21) Appl. No.: 11/229,028

(22) Filed: Sep. 15, 2005

Related U.S. Application Data
(60) Provisional application No. 60/615,140, filed on Sep. 30, 2004.

(51) Int. Cl. B29C 65/00

(52) U.S. Cl. 264/41; 424/423

(57) ABSTRACT

The present invention relates to methods of making and using composites and scaffolds as implantable devices useful for tissue repair, guided tissue regeneration, and tissue engineering. In particular, the present invention relates to methods of making and using compression molded resorbable thermoplastic polymer composites which can be subsequently processed with non-organic solvents to create porous, resorbable thermoplastic polymer scaffolds or composite scaffold with interconnected porosity. Furthermore, these composites or scaffolds can be coated with an organic and/or inorganic material.

### RELATED APPLICATIONS

This application claims priority to U.S. application Ser. No. 60/615,140 entitled Methods of Making and Using Composites, Polymer Scaffolds and Composite Scaffolds filed on Sep. 30, 2004, the contents of which are incorporated herein by this reference.

### BACKGROUND OF THE INVENTION

1. Field of the Invention

The present invention relates to methods of making and using composites and scaffolds as implantable devices useful for tissue repair, guided tissue regeneration, and tissue engineering. In particular, the present invention relates to methods of making and using compression molded polymer composites which can be subsequently processed with non-organic solvents to create porous polymer scaffolds or composite scaffolds with interconnected porosity. Furthermore, these composites or scaffolds can be coated with an organic and/or inorganic material.

2. Description of Related Art

The requirements for making composites and scaffolds for implantable devices are complex and specific to the structure and function of the tissue of interest. The composites and scaffolds serve as both physical support and adhesive substrates for isolated or host cells during in vitro culturing and subsequent in vivo implantation. Tissue repair or guided tissue regeneration devices can be used to support injured or diseased tissues or direct the growth of tissue during the repair period. Scaffolds, in particular, are utilized to deliver cells to desired sites in the body, to define a potential space for engineered tissue, and to guide the process of tissue development.

Prior to fabrication of the composites and scaffolds, characteristics including biocompatibility, resorbability and rate of degradation of the materials used as well as porosity, pore size, shape, distribution, presence of contaminating materials and mechanical strength of the resulting composite and scaffold must be carefully considered. Although various methods of manufacturing composites and scaffolds exist in the art (e.g., injection molding, extrusion, solvent-casting, phase separation, and rapid-protoyping) and can be useful techniques for specific applications, an efficient, cost-effective, general method for creating large scale, both heterogeneous as well as homogeneous composites and scaffolds of varying shapes and sizes does not exist.

Non-organic solvent based methods known to the art suffer from shortcomings that prevent their applicability to many procedures. Injection molding and extrusion, produces composites with a limited amount of particles or incompressible filler components that can be incorporated into the composite and thus produce low or poorly interconnected porosity in the cases where the particles are removed to create a porous scaffold. Similarly, other non-solvent based methods, such as textile-manufacturing produce composites or scaffolds with low compressive strength.

Furthermore, most of the prior art methods utilize organic solvents that can compromise the clinical efficacy of the composites and scaffolds fabricated using these methods. For example, the most commonly used method for fabricating composites and scaffolds is solvent casting and particulate leaching (see Mikos et al., Polymer, 35, 1068-77, (1994); de Groot et al., Colloid Polym. Sci., 268, 1073-81 (1991); Laurencin et al., J Biomed. Mater. Res., 30, 133-8 (1996)). However, this (and many other prior art methods) are organic solvent based methods. As is well known in the art, organic solvents are toxic to cells and tissues. Thus, prior to in vivo use, composites and scaffolds fabricated using organic based solvent methods must undergo time consuming and costly post fabrication processing. Organic solvents may also inactivate many biologically active factors that are to be incorporated into the polymer material.

Accordingly, there exists a need in the art for a general method that can be used to manufacture homogenous and heterogeneous composites and scaffolds of various shapes, sizes and dimensions that are clinically safe and can be manufactured on a large scale in a timely and cost efficient manner.

### SUMMARY OF THE INVENTION

The present invention provides a general method for manufacturing composites and scaffolds that are fabricated without the use of organic solvents. These composites and scaffolds are thus clinically safe upon manufacture and do not require time consuming and costly post fabrication processing. Furthermore, the method of manufacture of the present invention can be easily manipulated in terms of materials used, porosity, degradation rate, pore size, etc., such that a wide variety of homogenous and heterogeneous composites and scaffolds can be quickly manufactured on a large scale. The flexibility of this method also allows for manufacture of multiple shapes, sizes and forms of the composites and scaffolds thereby allowing for applicability, with minimal time and expense, to a wide variety of tissue engineering applications.

The composites and scaffolds manufactured using the present invention may be used to repair and/or regenerate tissues and organs, including but not limited to, bone, cartilage, tendon, ligament, muscle, skin (e.g. epithelial and dermal), liver, kidneys, heart valves, pancreas, urothelium, bladder, intestine, fat, nerve, esophagus, and other connective or soft tissues.

In general terms, the inventive non-organic solvent based method of manufacturing a composite material comprises placing one or more biocompatible polymers between one or more layer(s) of particles and compressing the particles into the polymers either with or without heat to thereby manufacture a composite. The polymer may be natural or synthetic, resorbable or non-resorbable and may be in the form of one or more sheets, blocks, pellets, granules or any other desired shape. Similarly, the particles may be in the form of a powder, granules, morsels, short fibers etc. In a preferred embodiment, the polymer is resorbable. In other embodiments, the polymer is comprised of a blend of two or more polymers. In certain embodiments, the particles are comprised of inorganic or ceramic material. In other embodiments, the particles are comprised of drugs or other biological agents. In certain embodiments, the particles are organic materials. In another preferred embodiment, the particles are substantially incompressible compared to the polymer.

To manufacture a porous scaffold, the particles from the composites manufactured as described above can be removed by dissolution or displacement using a non-organic solvent, e.g., water. The nature and extent of the pores can be controlled by the size of the particles used and the strength of the compression forces as well as the presence or absence of heat. In certain embodiments, two or more layers of differing particles sizes are used to create a heterogeneous composite and a resulting heterogeneous scaffold upon dissolution or displacement using a non-organic solvent. Similarly, scaffolds of varying dimensions and shapes can easily be manufactured by layering polymers within and between the particles prior to compression to create a complex or biologically-relevant shaped composite using the same polymer for each layer or differing polymers in each layer.

Furthermore, the composites or scaffolds described above can be coated with an organic or inorganic material. For example, the composites or scaffolds could be coated with an organic extracellular matrix (e.g. collagen, hyaluronic acid, proteoglycans, fibronectin, laminin, RGD sequences, etc.), a therapeutic agents (e.g. antibiotic, growth factor, chemoattractant, other drugs, etc), or cells. The composites or scaffolds could also be coated with an inorganic material such as a ceramic (calcium phosphates, calcium carbonates, calcium sulfates, bioglass, other silicas, etc), or metals, etc. A single component could be coated on the composites or scaffolds or multiple coatings with multiple components could be used. For example, a coating of collagen could be deposited on the outer surface of the composite or scaffold and then an apatite coating could be deposited on top of the collagen layer (or co-precipitated with the collagen), followed by addition of cells, e.g., adipose-derived regenerative cells.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description.

### BRIEF DESCRIPTION OF THE DRAWINGS

FIG. 1 depicts a stainless. steel confined mold.

FIG. 2 depicts a hydroxyapatite powder/polymer composite made with 85:15 poly(DL-lactide-co-glycolide) (PDLGa) (cut cross-sectional view).

FIG. 3A depicts an overview of a silica/85:15 PDLGa polymer composite and 3B depicts a cut cross-sectional view.

FIG. 4A depicts the top view of a barium sulfate/85:15 PDLGa polymer composite and 4B depicts a bottom view.

FIG. 5 depicts an aluminum cavity mold on top of a ferrotype plate.

FIG. 6A depicts an overview of a porous polypropylene scaffold and 6B depicts a cut cross-sectional view.

FIG. 7A depicts an overview of a porous 85:15 PDLGa scaffold and 7B depicts a scanning electron microscopic image of a cut corner (100×).

FIG. 8A depicts a cut cross-sectional view of a bilayered porous 85:15 PDLGa scaffold and 8B depicts a scanning electron microscopic image of a cut cross-section (60×).

FIG. 9A depicts whole porous 85:15 PDLGa morsels (pellets) and 9B depicts a cut cross-sectional view showing a very small solid polymer core.

FIG. 10A depicts whole porous morsels made from flattened raw polymer pellets being compression molded between layers of salt and 10B depicts cut cross-sections.

FIG. 11A depicts an overview of cut compression molded 85:15 PDLGa sheets made porous and 11B depicts cut cross-sections.

FIG. 12A depicts an overview of porous granules of 85:15 PDLGa and 12B depicts a scanning electron microscopic image of a single granule.

FIG. 13A depicts a cross-shaped compression molded 85:15 PDLGa sheet and 13B depicts a porous cross-shaped 85:15 PDLGa scaffold.

FIG. 14A depicts compression molded 85:15 PDLGa sheets cut into approximate ear-shapes and 14B depicts a porous approximate ear-shaped 85:15 PDLGa scaffold.

FIG. 15 depicts a porous 85:15 PLGA sheet made without a mold.

FIG. 16 depicts a thin porous 70:30 Poly(L-lactide-co-D,L-lactide) sheet.

FIG. 17 depicts the osteocalcin mRNA levels, relative to an uncoated scaffold, for adipose-derived regenerative cells cultured on 85:15 PDLGA scaffolds with various coatings. The differences of osteocalcin gene expression is shown in the different coatings of PDGLA (Collagen Only—Col only; Apatite Only—Ap only; Collagen First then Apatite—Col 1st; Apatite First then Collagen—Col last; Coprecipitation of Collagen and Apatite—Co-ppt). The values are expressed as fold change over the uncoated PDLGA scaffold

### DETAILED DESCRIPTION OF THE INVENTION

The present invention provides a non-organic solvent based, efficient and cost-effective method for making homogenous and heterogeneous composites and scaffolds of varying sizes and dimensions on a large scale that are useful for a wide variety of tissue engineering applications, including repair and regeneration of malfunctioning organs and fabrication of implants and prostheses. As set forth above, composites and scaffolds useful in fabricating skin, liver, pancreas, intestine, urothelium, esophagus, nerve, valve leaflet, cartilage, bone, ligament, tendon and other tissues have been developed. These prior art methods, however suffer from a number of disadvantageous. Notably, a large majority of these methods utilize an organic solvent based approach. As is well known in the art, the presence of residual solvents remaining in composites and scaffolds fabricated using the organic solvent based methods can have deleterious effects on cells and neighboring tissue and can compromise the ability of the cells to form new tissues in vivo. Solvent-based methods also are costly in time and money. Removal of the solvent requires a waiting period for the solvent to evaporate from the composite, followed by residual solvents being removed by vacuum or critical point drying. Cost associated with purchase of the organic solvents and hazardous waste disposal can be excessive.

Organic solvent based methods to manufacture scaffolds include, solvent casting-particulate leaching (SC-PL), gel/solution casting, phase separation or freeze drying (PS), solution based gas foaming (GF), and some of the rapid prototyping methods. Although the foregoing methods do have desirable characteristics, for example, the solvent casting-porogen leaching method allows for highly porous scaffolds, the use of organic solvents presents a complicating factor that undermines the safety and applicability of these methods. Similarly, although a few non-organic based fabrication methods are known in the art, these methods also suffer from shortcomings that prevent their widespread applicability in tissue engineering procedures. For example, the textile based method, which is a non-organic solvent based approach for manufacturing composites and scaffolds, produces composites and scaffolds with low mechanical strength and requires equipment that can be prohibitively expensive. Similarly, gas foaming, another non-organic solvent based method, produce scaffolds with low porosity or poor interconnectively, thereby largely eliminating this method's applicability in tissue engineering procedures. The gas foaming method may be combined with a porogen leaching step which can facilitate the presence of pores. However, before a polymer can be used with the gas foaming porogen leaching method, the polymer must be ground which adds considerable time and expense to the manufacturing process and can also serve to compromise the mechanical strength of the composite and/or scaffold. Although rapid prototyping methods, such as fused deposition modeling and stererolithography, have the ability to produce complex and biologically relevant shaped scaffolds via computer aided design techniques, these methods suffer from shortcomings such as limited porosity, limited resolution, and the requirement for expensive equipment.

In contrast, the method of the present invention, i.e., compression molding particles into polymer sheets, not only does not require the use of organic solvents, it can be performed with minimal time and expense to manufacture homogenous and heterogeneous composites and scaffolds of varying sizes and dimensions on a large scale with little or no manipulation of the general method. Other compression molding methods known in the art for scaffold fabrication require polymer grinding and sieving to obtain polymer particles of similar size as the inorganic particle and mixing of these particles prior to compression molding. This polymer grinding step is resource intensive and results in poor particle yield. This type of compression method also produces weak scaffolds at the higher porosities. In a general embodiment, the inventive method comprises manufacturing a composite by placing one or more biocompatible thermoplastic polymer solids between one or more layers of particles and compressing the particles into the polymer solid either with or without heat. The embedded particles can be left in place as a composite device or one or more of the particle types can be removed by dissolution or displacement using, for example, a non-organic solvent such as water to manufacture a porous scaffold or porous composite. The composites and scaffolds may be used to repair and/or regenerate cells, tissue and organs including, but not limited to, bone, cartilage, tendon, ligament, muscle, skin (epithelial and dermal), liver, kidneys, pancreas, urothelium, bladder, intestine, fat, nerve, and other connective or soft tissues.

As further described herein, in addition to homogenous composites and scaffolds manufactured by the present method, heterogeneous or multimodal composites and scaffolds may also be manufactured. All of the composites and scaffolds can be manufactured on a large scale with minimal time and expense. The manufacture of three-dimensional bimodal scaffolds is of particular importance since most of the current approaches use one type of scaffold material to promote one type of cell growth. However, there exist very few biological tissues, with skin and cartilage being possible exceptions, that can be accurately fabricated using only one type of cell supported on one type of scaffold. Most tissues are made up of numerous different cell types, each of which requires a different scaffold, possibly different growth factors, as well as different blood vessel architecture to ensure viability. For example, a limb is comprised of bone, muscle and tendon. Scaffolds such as hydroxyapatite, useful to support bone cells, are too brittle and non-pliable to act as scaffolding for muscle or tendons. Other heterogeneous tissues, such as liver and kidney, are even more complex. Most current scaffolds and tissue engineering techniques fail to permit heterogeneous tissues to be grown or provided with blood vessels. The present invention's capability to create composites and scaffolds with heterogeneous materials and morphology enables the repair and regeneration of tissues and collections of tissues to a greater degree than prior art methods, and exhibits more accurate histological structure and function than can be achieved with homogeneous composites and scaffolds alone. This capability permits different cells to be strategically placed in different regions of the scaffold, allowing each region to be composed of the optimal scaffold material and microstructure for organizing and stimulating the growth of cells in that region. As another example, the particulates can be embedded partially into the polymer solid rendering the surface different than the core of the device. This may have applications for many tissue types, such as bone, where an osteoconductive ceramic embedded surface would be desireable. This has advantages in that the overall device property may be dictated by the core material (i.e. mechanical properties or degradation rate), but the embedded surface particles are host tissue friendly.

Another advantage of the present method is the absence of organic solvents. As is well known in the art, the presence of organic solvents generally compromises the ability of cells to form new tissues in vivo. Thus, long processing times to fully remove these solvents are necessary for prior art methods. The present invention overcomes this problem by using combinations of materials and non-organic solvent based pore forming techniques that can be manipulated for widespread use to aid patients suffering from various types of organ and tissue failure.

The physical characteristics of the composites and scaffolds must be carefully considered when designing a substrate to be used in tissue engineering or repair. As is known in the art, in order to promote tissue growth, the scaffold must have a large surface area to allow cell attachment. This is usually done by creating highly porous scaffolds wherein the pores are large enough such that cells can penetrate the pores. Furthermore, the pores must be interconnected to facilitate nutrient and waste exchange by the cells. These characteristics, i.e., interconnectivity and pore size, are often dependent on the method of fabrication. The composites and scaffolds fabricated using the present invention have interconnected porosity which is lacking in many prior art methods such as solvent casting—porogen leaching due to the presence of surface film or closed pores. Moreover, unlike prior art methods such as gel/solution casting, phase separation freeze drying, solution based gas foaming and others, the composites and scaffolds produced by the present method allows for a fair amount of control over the size of the pores in the resulting scaffolds.

The first characteristic to consider when manufacturing composites and scaffolds is the choice of materials. It is understood that if the composites or scaffolds are manufactured for therapeutic use, all components used must be biocompatible. Accordingly, in considering substrate materials, it is imperative to choose one that exhibits clinically acceptable biocompatibility. In addition, the mechanical properties of the scaffold must be sufficient so that it does not collapse during the patient's normal activities. Both natural (e.g., collagen, elastin, poly(amino acids), and polysaccharides such as hyaluronic acid, glycosamino glycan, carboxymethylcellulose); and synthetic polymer materials may be used to manufacture the composites and scaffolds of the present invention. The polymer material may be in the form of one or more of sheet(s), blocks(s), pellets, granules, or any other desirably shaped polymer material.

In a preferred embodiment, the polymer is a resorbable material eliminating the need for a second surgery to remove the composite or scaffold. Exemplary synthetic resorbable polymers that may be used include, poly(glycolic acid) (PGA), poly(L-lactic acid) (PLLA), poly(D-lactide) (PDLA), poly(D,L-lactide) (PDLLA), polycaprolactone (PCL), poly-p-dioxanone (PDO) and polytrimethylene carbonate (PTMC) and their copolymers, as well as polyanhydrides, polyhydroxy butyrate, polyhydroxyvalerate, “pseudo” polyaminoacids (eg. (polyarylates and polycarbonates), polyesteramides (PEA), polyphosphazenes, polypropylene fumarates, and polyorthoesters and copolymers or multipolymers of these with each other and resorbable multi- or copolymers that combine one or more resorbable component with a nonresorbable component (e.g. poly(lactide-co-ethylene oxide)) thereby making the copolymer resorbable. These polymers offer distinct advantages in that their sterilizability and relative biocompatibility have been well documented. Also, their resorption rates can be tailored to match that of new tissue formation. In a preferred embodiment, the scaffold is constructed of 70:30 poly(L-lactide-co-D,L-lactide). In another embodiment, the scaffold is constructed of 85:15 poly(D,L-lactide-co-glycolide). In addition, nonresorbable synthetic polymers, such as polyethylene, polypropylene, polyvinyl chloride, polyethylene terephthalate, polyetherether ketone, polyamides and polyurethanes may also be used. Furthermore, any combination of the foregoing, e.g., a synthetic polymer and a natural polymer, a resorbable polymer and a non-resorbable polymer, a blend of two types resorbable or non-resorbable polymers etc. may be used.

It is understood in the art that desired resorption rates of the composites and scaffolds will vary based on the particular therapeutic application. The rates of resorption of the composites and scaffolds may also be selectively controlled. For example, the scaffold may be manufactured to degrade at different rates depending on the rate of recovery of the patient from a surgical procedure. Thus, a patient who recovers more quickly from a surgical procedure relative to an average patient, may be administered an agent that for example is selective for the polymeric material of the scaffold and causes the scaffold to degrade more quickly. Or, if the polymeric material is, for example, temperature sensitive or is influenced by electrical charge, the area in which the device has been implanted may be locally heated or cooled, or otherwise exposed to an electrical charge that causes the device to dissolve at a desired rate for the individual patient.

Once the appropriate polymeric material or combination of materials is selected, an appropriate particle must be chosen. The particles that may be used with the method of the present invention are inorganic particles including, but not limited to, Hydroxyapatite, di-, tri-, and tetra-calcium phosphate, calcium orthophosphates, and other derivatives of calcium phosphates (e.g. octocalcium phosphate, monocalcium phosphate monohydrate, biphasic calcium phosphates), phosphorous pentaoxide, calcium sulfate, calcium carbonate, silicon dioxide, calcium oxide, sodium oxide, silver oxide, zinc oxide, and sodium chloride or combinations of the above (e.g. bioglass), and metals such as titanium. The size of the particles will vary depending on the polymeric material used. In general, the particles should be of sufficient diameter to allow the particles to be embedded within the polymeric material upon application of compression forces. In certain embodiments, the particles are substantially incompressible compared to the polymer solid, either due to the difference in their inherent mechanical properties or because they have substantially disparate thermal characteristics. An exemplary range of particulate size is 1 micron-3 mm.

The particles may be in any form including a powder, granules, morsels, or short fibers. In a preferred embodiment, the particles comprise an inorganic or ceramic material; including, but not limited to, calcium phosphates (hydroxyapatite, tricalcium phosphate, etc), bioglasses, silicon dioxide, or salts (such as sodium chloride). In another preferred embodiment, the particles comprise a drug or biological agent, including but not limited to, growth factors, antibiotics, hormones, vitamins or cells, e.g., regenerative cells such as stem cells or progenitor cells. For example, the scaffolds produced using the methods of the present invention can be seeded with a therapeutically effective dose of adipose derived regenerative cells, e.g., adult stem and progenitor cells as described in U.S. application Ser. No. 10/316,127. In other embodiments, the particles comprise an organic material; including but not limited to, a polymer or a sugar with differing thermal characteristics than the polymer solid. In preferred embodiments, two or more layers of differing particles sizes are used in the method of the present invention to create a heterogeneous composite. Another key advantage of the present method is the demonstrated ability to fabricate specific geometric shapes, including spheres of various sizes, angles, and complex biologically relevant forms.

In certain embodiments, to create a composite, the particles are embedded to varying degrees within the polymer. The compression can be accompanied by heat (i.e., thermal compression) depending on the mechanical and thermal properties of the polymer, the particles and the desired properties of the resulting composite or and/or scaffold. For the same reasons, the compression can be accomplished without the use of heat. The use of thermal versus non-thermal compression will be evident to one of ordinary skill in the art. For example, when embedding particles such as drugs or other easily denatured substances into the polymer, the use of heat may have to be reduced and possibly eliminated. The temperature ranges that can be used with the thermal compression methods are dependent on the thermal and mechanical characteristics of the polymer solid and particles. The amount of compression forces that may be used can similarly be dictated by the properties of the polymers, particles and the desired composite and scaffolds. The compression forces, temperature, and particle sizes, can be controlled to force the small particles partly or completely throughout the solid polymer. The compression forces, temperature and particle types and sizes can also be used to manipulate the type of composite and resulting scaffold that is produced, i.e., homogenous or heterogeneous.

In certain embodiments, two or more types of inorganic particles can be embedded into one or more types of polymer solids. Prior to compression, the polymer and particles may be appropriately layered on a mold in a desirable shape and size. The choice of a mold will dictate the specific shapes, configurations and sizes needed for a particular tissue engineering application. A variety of molds are known in the art and are intended to be encompassed by the present invention. Use of a few molds, e.g., confined molds, cavity molds and plates, are exemplified herein and are not intended to be limiting examples. It is understood that a composite or scaffold formed using such molds can be further shaped at the time of surgery by cutting or bending. May bring the material to its glass transition temperature, using heating iron, hot air, heated sponge or hot water bath methods.

In order to create a porous scaffold from the composite with interconnected pores throughout, the particles may be dissolved by a non-organic solvent, e.g., water. Exemplary materials and methods related to making and using all aspects of the present invention are disclosed in, for example, U.S. Pat. Nos. 5,919,234, 6,280,473, 6,269,716, 6,343,531, 6,477,923, 6,391,059, 6,531,146 and 6,673,362, the contents of which are incorporated herein by this reference.

Any of the composites and/or scaffolds described herein may be coated with an inorganic substance, such as ceramics (e.g. calcium phosphates, calcium carbonates, calcium sulfates, bioglass, other silicas, etc), or metals, etc An apatite coating can be created using a simulated body fluid (SBF) solution. The SBF solutions may be prepared with ion concentrations approximately 0-10 times that of human blood plasma and can be sterile filtered through a 0.22 μm PES membrane or a similar membrane filter. Methods of making art-recognized SBF solutions and variations thereof for use in the present invention can be found in, e.g., Chou et al. (2005) The Effect of Biomimetic Apatite Structure on Osteoblast Viability, Proliferation and Gene Expression Biomaterials 26: 285-295; Oyane et al. (2003) Preparation and Assessment of Revised Simulated Body Fluids J. Biomed mater Res 65A: 188-195; Murphy et al. (1999) Growth of Continuous Bonelike Mineral Within Porous Poly(lactic-co-glycolide) Scaffolds In Vitro J. Biomed. Mater. Res. 50: 50-58. The composites and/or scaffolds may also be treated with glow discharge, argon-plasma etching prior to being soaked in the SBF solution to improve wettability and affinity for the SBF ions. Different apatite microenvironments can be created on the composites or scaffold surfaces by controlling the SBF concentration, components, pH and the duration of the scaffold or composite in each SBF solution. Vacuum or fluid flow (directed or non-directed) can be used to force the SBF into the pores of the scaffold. Other methods know to the art, such as spraying coating, can be used to applied the coating to composite or scaffold surfaces.

Any of the composites and/or scaffolds described herein may be coated with an organic substance, such as extracellular matrix constituents (e.g. collagen or other proteins, hyaluronic acid, proteoglycans or other polysaccharides, fibronectin, laminin, RGD sequences, etc.), therapeutic agents (e.g. antibiotic, growth factors, chemoattractants, cytokines, other drugs, etc), or cells to facilitate cell or tissue incorporation into the composite or scaffold. The organic substance can be coated on the surface of the composite or scaffold by immersing the device into an aqueous solution of the substance, such as in phosphate buffered saline (PBS), and allowed the protein to precipitate onto the scaffold surfaces over time either statically or with agitation or it could be sprayed, covalently crosslinked, or applied onto the composite or scaffold surface by some other appropriate method known to those skilled in the art.

A single component could be coated on the composites or scaffolds or multiple coatings with multiple components could be used. For example, a coating of collagen could be deposited on the outer surface of the composite or scaffold and then an apatite coating could be deposited on top of the collagen layer (or co-precipitated with the collagen), followed by adipose-derived regenerative cells.

### EXAMPLES

### Example 1

This example describes the preparation of a composite of inorganic particles embedded within the outer regions of a thermoplastic polymer solid using thermal compression molding.

First, a solid polymer sheet of 85:15 poly(DL-lactide-co-glycolide) (PDLGa) which is a resorbable polymer with known biocompatible characteristics having an approximate thickness of 0.7 mm and a diameter of 37 mm was made by thermal compression molding. Specifically, one gram of the polymer was placed between ferrotype plates along with a 0.75 mm spacer cavity and heating on the lower plate of an Autoseries Carver press for three minutes at 300° F. The pre-heated polymer was then pressed between the plates for forty-five seconds at 48,0000 pounds at the same temperature of 300° F. After cooling the polymer sheet was removed from the ferrotype plates.

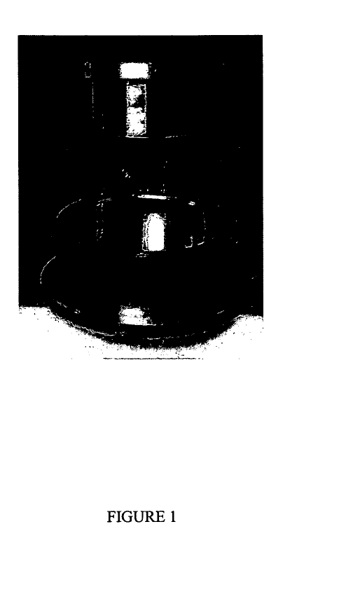

To make the hydroxyapatite/polymer composite, 5 g of hydroxyapatite (HAp) powder was placed in the bottom of a confined stainless steel mold having an inner diameter of 50 mm and wall thickness of 5 mm (FIG. 1). The 0.7 mm thick/37 mm diameter compression molded polymer sheet was placed on top of the layer of 5 g of HAp powder and then another 5 g of HAp powder was layered on top of the polymer sheet. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes. After cooling the composite material was removed from the mold and the excess HAp powder was brushed away.

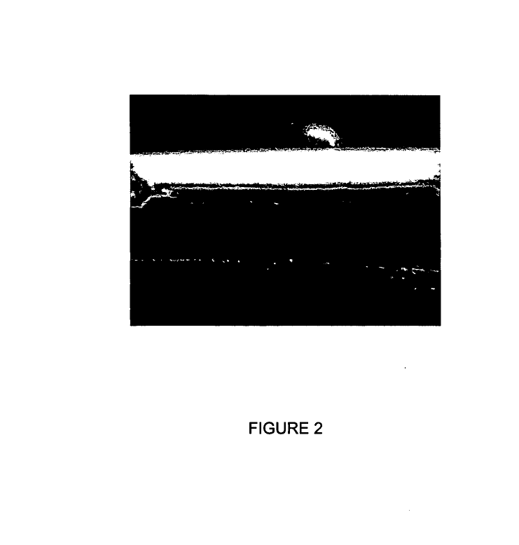

The resulting composite consisted of a polymer sheet with HAp powder embedded into the exterior regions of the polymer solid (FIG. 2). Such a composite may be particularly useful for bone repair and regeneration and other bone related tissue engineering applications.

### Example 2

This example describes the preparation of a homogeneous composite of inorganic particles embedded entirely throughout a thermoplastic polymer solid using thermal compression molding.

A 0.7 mm thick/37 mm diameter sheet of 85:15 PDLGa polymer was prepared as described in Example 1 above. To make the silica/polymer composite, 20 g of silicon dioxide, in the form of play sand as a model material, was place in the bottom of a confined stainless steel mold having an inner diameter of 50 mm and wall thickness of 5 mm (FIG. 1). The 0.7 mm thick/37 mm diameter compression molded polymer sheet was place on top of the layer of silica and then another 20 g of silicon dioxide was layered on top of the polymer sheet. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360 ° F. for 4 minutes. After cooling the composite material was removed from the mold and the excess silicon dioxide was brushed away.

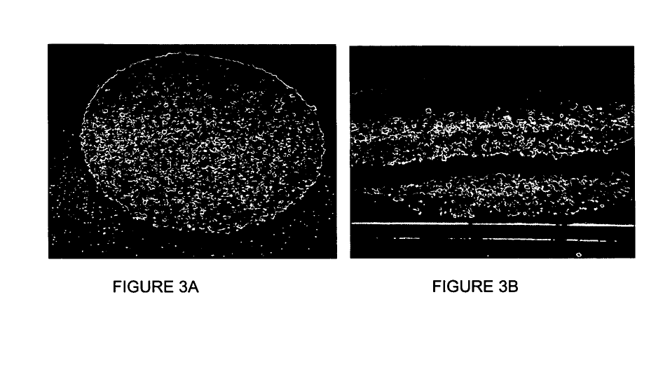

The resulting composite consisted of a homogenous composite of silicon dioxide embedded into the polymer solid (FIG. 3). This composite may also be particularly useful in bone related repair and regeneration applications as silicon dioxide simulates the bone bonding properties of bioglass.

### Example 3

This example describes the preparation of a composite of inorganic beads embedded within one surface of a thermoplastic polymer using thermal compression molding.

A 0.7 mm thick/37 mm diameter sheet of 85:15 PDLGa polymer was prepared as described in Example 1. To make the barium sulfate/polymer composite, 12 g of sodium chloride (sieved to diameter range of 425-710 um), was placed in the bottom of a confined stainless steel mold having an inner diameter of 50 mm and wall thickness of 5 mm (FIG. 1). The 0.7 mm thick/37 mm diameter compression molded polymer sheet was place on top of the layer of sodium chloride and then 9 g of barium sulfate beads were layered on top of the polymer sheet with an additional 10 g of salt placed on top of that. The plunger of the confined mold was placed on top and the materials were compressed using a 2 stage procedure. The first stage of compression was carried out at 360° F. at 1,000 pounds of pressure for 8 minutes. Next, the materials were compressed further using 10,000 pounds of force at 360° F. for 4 minutes. After cooling the composite material was removed from the mold and the excess salt was leached away using water.

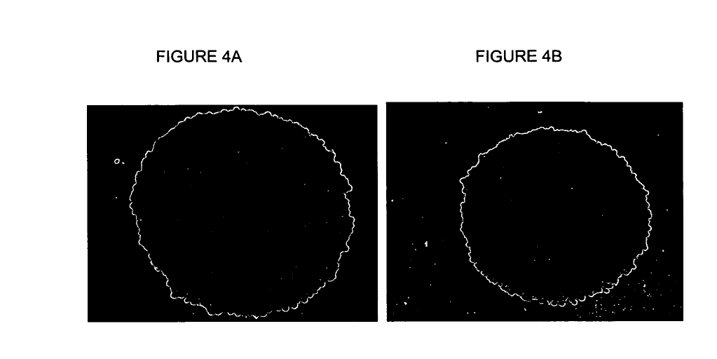

The resulting composite consisted of a polymer sheet with barium sulfate beads embedded into one side of the polymer solid (FIG. 4). The barium sulfate beads are a resorbable radiopaque material that are significantly larger than the particles used in previous examples (bead diameter roughly 2-3 mm, particle width typically less than lmm) and have resorption profile that is different than that of the PDLGA polymer. Thus, if the salt were to be leached out from the composite manufactured in this example, an interconnected resorbable scaffold would be created that would be simultaneously embedded with ‘beads’ of a different resorption profile. It is understood that other permutations of this method, e.g., use of any resorbable or nonresorbable polymer, combined with any resorbable or non resorbable ‘beads’, combined with any dissolvable ‘particles’ could be used.

### Example 4

This example describes the preparation of a composite of inorganic particles embedded within the outer regions of a thermoplastic polymer solid by thermal compression molding within a cavity mold and subsequently removing the particles by dissolution in a non-organic solvent to create a porous surface.

Composites can also be compressed in a cavity mold, as opposed to the confined mold cited in examples 1-3. In addition, if the particulates are soluble in a solvent that is a non-solvent for the polymer solid, they can be leached from the composite to create a porous structure.

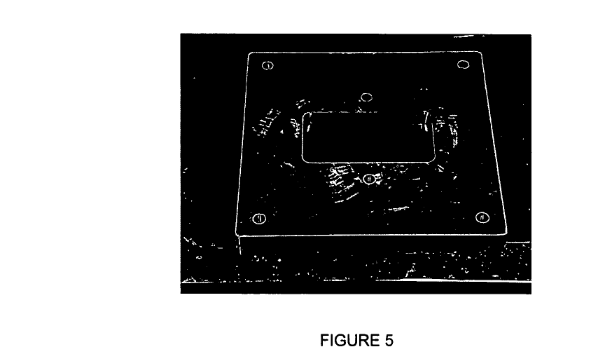

A polypropylene sheet, which is a biocompatible non-resorbable polymer, was obtained by cutting the bottom from a standard polypropylene container having thickness 1.3 mm to an approximate diameter of 22 mm (0.46 g). To make the sodium chloride/polymer composite, 30 g of sodium chloride (sieved to diameter range of >355 □m) was place in the bottom of a cavity mold set on top of a ferrotype plate having an inner dimensions of 40 mm×78 mm×8.3 mm tall (FIG. 5). The polypropylene sheet was place on top of the layer of sodium chloride and then 30 g more of NaCl was layered on top of the polymer sheet. Another ferrotype plate was placed on top and the materials were preheated for 8 min on the bottom plate of an Autoseries Carver press at 390° F., then compressed with 20,000 pounds of pressure for 4 minutes. After cooling, the composite material was removed from the mold. In order to determine where the inorganic material was embedded, the excess salt was leached away by soaking in water under agitation for 2-3 days with frequent water changes. The resulting scaffold was fractured and viewed to determine where the inorganic particles resided within the scaffold

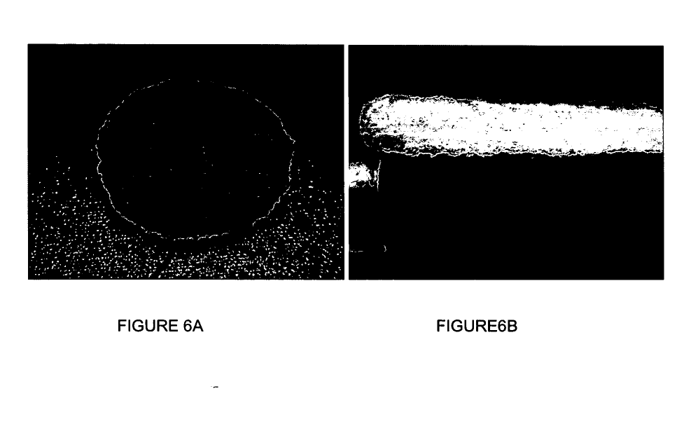

The resulting scaffold consisted of a polymer sheet with pores that extended partially into the polypropylene sheet (FIG. 6).

### Example 5

This example describes the preparation of a homogeneous composite of inorganic particles embedded entirely throughout a thermoplastic polymer by thermal compression molding within a confined mold and subsequently removing the particles by dissolution with a non-organic solvent to create a scaffold with interconnected pores throughout.

A solid can be made porous throughout if the particles are pressed entirely into and throughout the polymer material and subsequently leached out. A 0.7 mm thick/37 mm diameter sheet of 85:15 PDLGa polymer was prepared as described in Example 1. To make the sodium chloride/polymer composite, 15 g of sodium chloride (sieved to particle sizes 250-500 □m) was place in the bottom of a confined stainless steel mold having an inner diameter of 50 mm and wall thickness of 5 mm (FIG. 1). Then the 85:15 PDLGa sheet was place on top of the layer of salt and then another 15 g of NaCl (250-500 □m) was layered on top of the polymer sheet. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

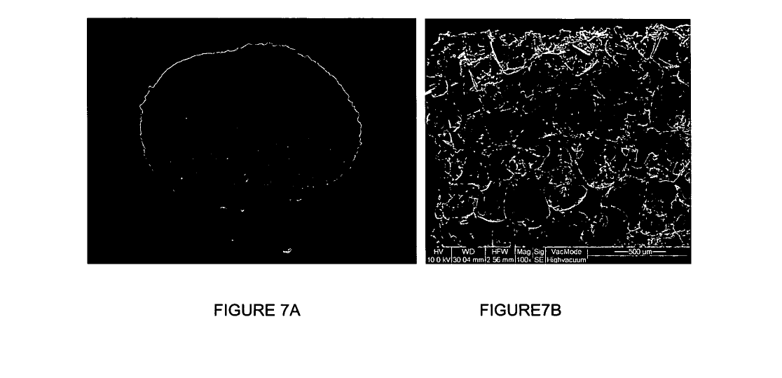

After cooling the composite material was removed from the mold and the excess salt from the outside and inside of the polymer solid was leached away by soaking in water under agitation for 2-3 days with frequent water changes. The resulting scaffold was highly porous and had over an 8 fold increased in thickness (final thickness of approximately 6 mm (FIG. 7). The approximate total porosity of the scaffold was calculated by the density method to be 89%.

### Example 6

This example describes the preparation of a bimodal or heterogeneous composite and scaffold by simultaneously compressing inorganic particles of one size range into one side of a thermoplastic polymer and inorganic particle of another size range into the other side of the polymer by thermal compression molding within a confined mold and then subsequently removing the particles by dissolution with a non-organic solvent to create a bimodal porous structure. A composite with differing particle sizes, or different particle materials, or differing pores sizes if the particulates are leachable, can be made by using varying particle sizes or particle materials. For example, heterogeneous composites and scaffolds can be made of two or more different polymer materials or particulates and could be trimodal or quadruple modal.

A sodium chloride/polymer composite was manufactured as a bilayered composite. A 0.7 mm thick/37 mm diameter sheet of 85:15 PDLGa polymer was prepared as described in example 1. To make the bilayered sodium chloride/polymer composite, 15 g of sodium chloride (sieved to particle sizes 425-710 □m) was place in the bottom of a confined stainless steel mold having an inner diameter of 50 mm and wall thickness of 5 mm (FIG. 1). Then the 85:15 PDLGa sheet was place on top of the layer of salt. Then, 15 g of NaCl (sieved to particle sizes 75-150 □m) was layered on top of the polymer pellets. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

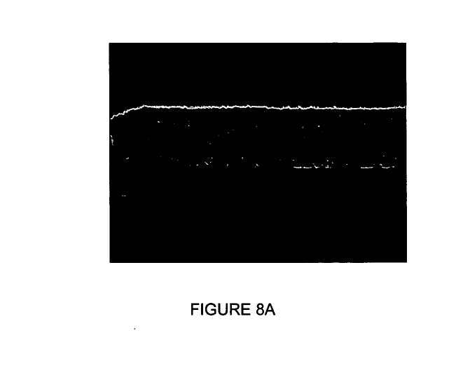

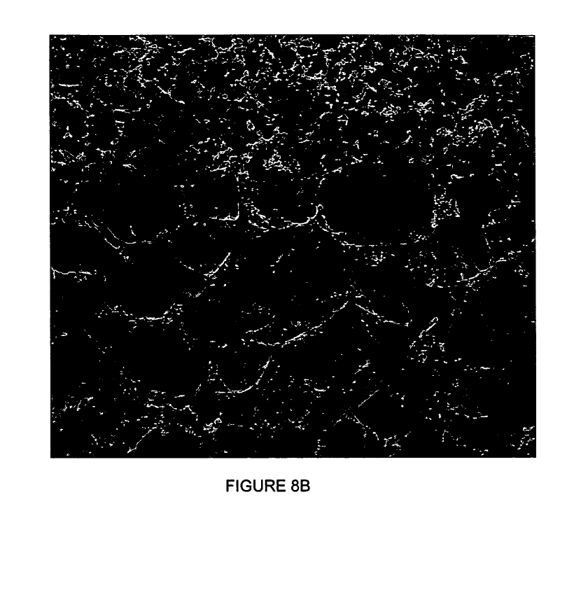

After cooling, the composite material was removed from the mold and the excess salt from the outside and inside of the polymer solid was leached away by soaking in water under agitation for 2-3 days with frequent water changes. The resulting heterogeneous scaffold had a thin region of small pores on one side of the device (top side in FIG. 8) and a thick region of a larger pores on the other side of the device (bottom side in FIG. 8)

As previously set forth herein, heterogeneous composites and scaffolds are of particular utility in tissue engineering applications due to scenarios in which different pore sizes, mechanical strength and other scaffold characteristics may be required within the same tissue type or organ. For example, a scaffold with bone compatible pores on one surface and cartilage compatible pores on another surface may be optimal. Similarly, certain applications may require different bonding characteristics on one side of the scaffold versus another side. This example demonstrates that a variety of heterogeneous composites and scaffolds can be manufactured.

### Example 7

This example describes the preparation of composite morsels with inorganic particles embedded in the outer regions of raw thermoplastic polymer pellets by thermal compression molding within a confined mold and subsequently removing the particles by dissolution with a non-organic solvent to create composite morsels with a thick porous surface.

In some applications, composite morsels are desirable because they are easy to pack and manipulate into desired shapes without resorting to cutting of polymer sheets etc. which can be tedious and inefficient. The composites morsels could be a composite of two or more solid materials, or a scaffold or composite scaffold created by a leachable material.

Composite morsels were created by compressing sodium chloride particles into pellets of the thermoplastic polymer 85:15 PLGA. Specifically, 15 g of sodium chloride (sieved to particle sizes 250-425 μm), was place in the bottom of a confined stainless steel mold having an inner diameter of 50 mm and wall thickness of 5 mm (FIG. 1). Then 0.75 g of raw 85:15 PLGA polymer pellets was place on top of the layer of salt and then another 15 g of NaCl (250-425 μm) was layered on top of the polymer pellets. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

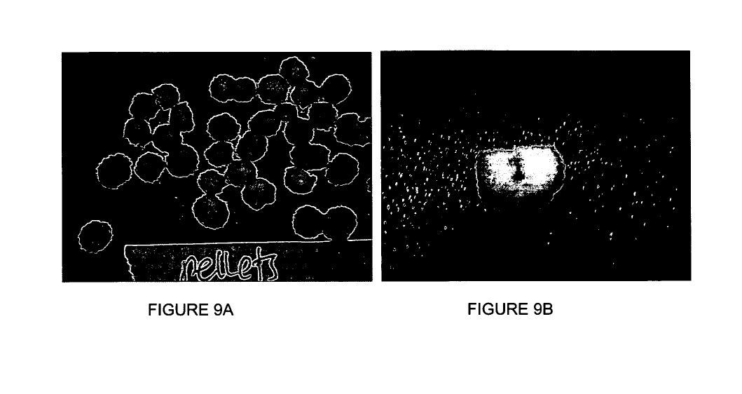

After cooling, the composite morsel material was removed from the mold and the excess salt from the outside and inside of the polymer solid was leached away by soaking in water under agitation for 2-3 days with frequent water changes. The resulting porous scaffold morsels were highly porous (FIG. 9A), but a small solid core still remained in the center of the porous pellets (morsels) (FIG. 9B).

### Example 8

This example describes the preparation of homogeneous composite morsels of inorganic particles embedded entirely throughout pre-flattened raw thermoplastic polymer pellets by thermal compression molding within a confined mold and subsequently removing the particles by dissolution with a solvent to create polymer morsels with interconnected pores throughout.

In order to avoid the solid polymer core found in the composite morsels and scaffold morsels prepared in Example 7, the polymer pellets were compression molded into small flat discs prior to being placed between layers of salt. The pre-flattened pellets were made by spreading a single layer of pellets, space apart from each other, between two ferrotype platens using a 0.75 mm spacer. The pellets were then preheated on the bottom platen of an Autoseries Carver press for 3 minutes at 300° F. and then compressed with 10,000 pounds of force for 45 seconds. After cooling, the pre-flattened pellets were placed between two layers of 15 g NaCl (250-425 μm) in the 50 mm inner diameter confined mold (FIG. 1) and compressed using a 2 stage procedure. The first stage of compression was carried out at 360° F. at 1,000 pounds of pressure for 8 minutes. Next, the materials were compressed further under 10,000 pounds of force at 360° F. for 4 minutes.

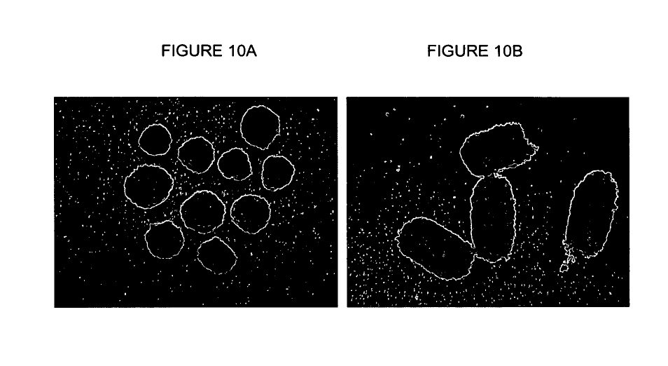

After cooling, the composite morsel material was removed from the mold and the excess salt from around the pellets and inside of the pellets was leached away by soaking in water under agitation for 2-3 days with frequent water changes. The resulting porous scaffold was highly porous throughout and the solid core was no longer present (FIG. 10B).

### Example 9

This example describes the preparation of small composites morsels with inorganic particles embedded entirely throughout cut up thermoplastic polymer sheets by thermal compression molding within a confined mold and subsequently removing the particles by dissolution with a non-organic solvent to create scaffold morsels with interconnected pores throughout.

A compression molded 85:18 PLGA sheet was made as described in Example 1. This sheet was then cut up into small particles of approximate size 1 mm×1 mm and placed between two layers of 15 g NaCl (250-425 μm) in a 50 mm inner diameter confined mold (FIG. 1) and compressed using a 2 stage procedure. The first stage of compression was carried out at 360° F. at 1,000 pounds of pressure for 8 minutes. Next, the materials were compressed further under 10,000 pounds of force at 360° F. for 4 minutes.

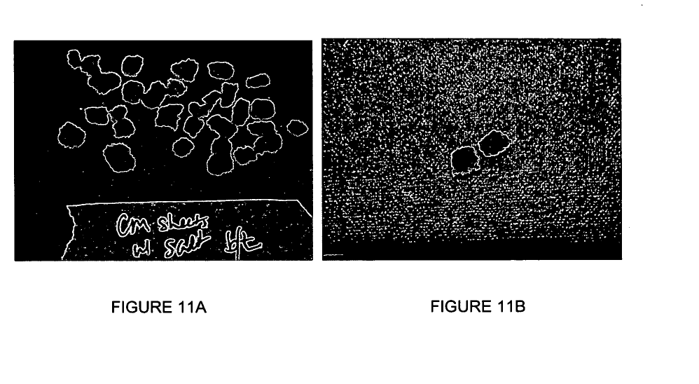

After cooling, the composite morsel material was removed from the mold and the excess salt from around the pellets and inside of the pellets was leached away by soaking in water under agitation for 2-3 days with frequent water changes. The resulting porous scaffold were highly porous throughout and no solid core was present (FIG. 11).

### Example 10

This example describes the preparation of small composites morsels of inorganic particles embedded entirely throughout raw thermoplastic polymer granules by thermal compression molding within a confined mold and subsequently removing the particles by dissolution with a non-organic solvent to create polymer particles with interconnected pores throughout.

Small composite morsels can be made by starting with smaller polymer pellets or granulated raw polymer. These smaller porous morsels or granules were created by compressing sodium chloride particles into granulated (<2 mm) raw 85:15 PLGA obtained from the polymer manufacturer. To make the sodium chloride/polymer composite granules, 15 g of sodium chloride (sieved to particle sizes 250-425 μm), was placed in the bottom of a confined stainless steel mold having an inner diameter of 50 mm and wall thickness of 5 mm (FIG. 1). Then 0.75 g of granulated (<2 mm) raw 85:15 PLGA obtained from the polymer manufacturer was place on top of the layer of salt. Then, another 15 g of NaCl (250-425 μm) was layered on top of the polymer granules. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

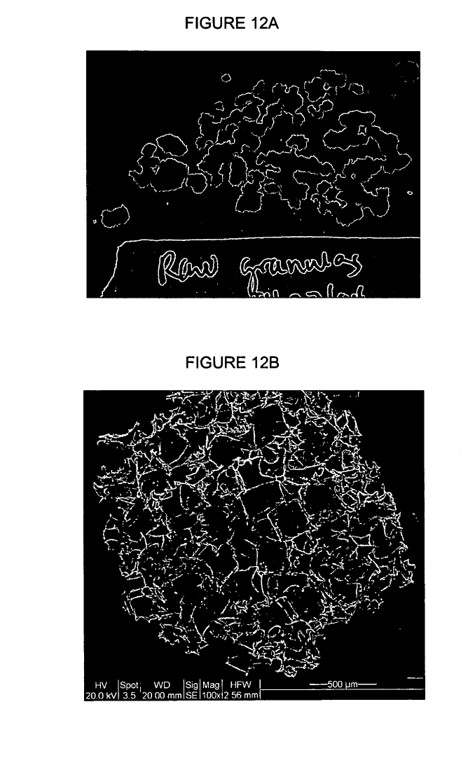

After cooling, the composite material was removed from the mold and the excess salt from the outside and inside of the polymer solid was leached away by soaking in water under agitation for 2-3 days with frequent water changes. The resulting porous scaffold was highly porous throughout (FIG. 12).

### Example 11

This example describes preparation of a composite in geometrically specific shapes by compressing inorganic particles into a geometrically-specific shaped thermoplastic polymer solid by thermal compression molding within a confined mold and subsequently removing the particles by dissolution with a solvent to create a porous geometrically-specific shaped polymer.

The final shape of the composite can be controlled by the shape of the polymer solid. A sodium chloride/polymer composite was manufactured as described. A 0.7 mm thick/37 mm diameter sheet of 85:15 PDLGa polymer was prepared as described in example 1 and then cut into the shape of a cross. To make the sodium chloride/polymer composite, 15 g of sodium chloride (sieved to particle sizes 250-425 μm) was place in the bottom of a confined stainless steel mold having an inner diameter of 50 mm and wall thickness of 5 mm (FIG. 1). Then the cross-shaped 85:15 PDLGa sheet was place on top of the layer of salt and then another 15 g of NaCl (250-425 μm) was layered on top of the polymer sheet. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

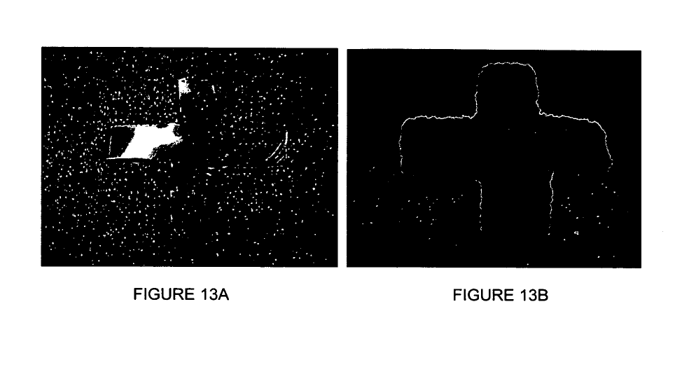

After cooling, the composite material was removed from the mold and the excess salt from the outside and inside of the polymer solid was leached away by soaking in water under agitation for 2-3 days with frequent water changes. The resulting scaffold retained the cross shape and was porous due to the removal of the salt particulates by leaching (FIG. 13).

### Example 12

This example describes preparation of a composite in a complex 3D shape by compressing inorganic particulates into multiple stacked geometrically-specific shaped thermoplastic polymer solids by thermal compression molding within a confined mold and subsequently removing the particles by dissolution with a solvent to create a porous complex or biologically relevant-shaped polymer.

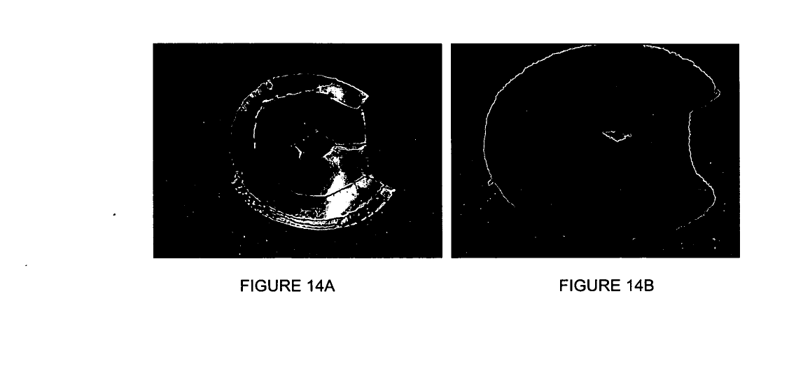

Two or more polymer solids can be layered and fused together using this compression method. For example, a device in the approximate shape of an ear was manufactured. Two 0.7 mm thick/37 mm diameter sheet of 85:15 PDLGa polymer were prepared as described in example 1 and then cut into the shapes shown in FIG. 14A. To make the biologically relevant shaped sodium chloride/polymer composite, 15 g of sodium chloride (sieved to particle sizes 425-710 μm) was place in the bottom of a confined stainless steel mold having an inner diameter of 50 mm and wall thickness of 5 mm (FIG. 1). Then the 85:15 PDLGa sheets were place on top of the layer salt with a single layer of salt layered between the two polymer sheets and another 15 g of NaCl (425-710 μm) was layered on top. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

After cooling, the composite material was removed from the mold and the excess salt from the outside and inside of the polymer solid was leached away by soaking in water under agitation for 2-3 days with frequent water changes. The resulting scaffold retained the ear-shape and the two polymer sheets were firmly fused together. The device was porous due to the removal of the salt particulates by leaching (FIG. 14).

### Example 13

This example describes preparation of a composite of inorganic particles embedding within a thermoplastic polymer by thermal compression molding between two platens and subsequently removing the particles by dissolution with a solvent to create a thin porous polymer.

Thinner composite or porous devices can be manufactured by compressing the particles into the solid polymer material between two platens without using a mold. As a proof of concept a sodium chloride/polymer composite was manufactured by placing 22 g of salt (>355 μm) on a ferrotype plate. A 85:15 PLGA sheet manufactured having thickness 0.425 mm was placed on top of the salt. Then 18 g of salt was placed on top of the polymer sheet above which another ferrotype plate was placed. The materials were preheated on the bottom platen of an Autoseries Carver press for 4 minutes at 360° F. and then compressed using 6,000 pounds of force for 150 seconds.

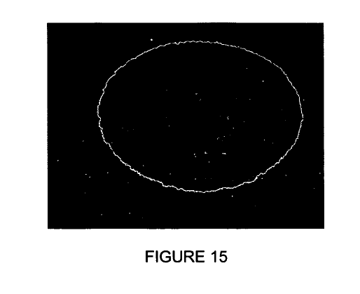

After cooling, the excess salt from around and within the polymer was leached away by soaking in water under agitation for 2-3 days with frequent water changes. The resulting scaffold sheet was porous and had a final thickness of approximately 2.7 mm (FIG. 15).

### Example 14

This example describes the preparation of a very thin composite of inorganic particles embedding within a thermoplastic polymer sheet by thermal compression molding within a confined mold and subsequently removing the particles by dissolution with a solvent to create a thin porous scaffold.

Another way to prepare a very thin composite or porous material is to start with a very thin polymer solid. First, a very thin 70:30 poly(L-lactide-co-D,L-lactide) (PLDLa) polymer sheet was made by melt extrusion to a thickness of 0.05 mm. To make the salt/polymer composite, 15 g of sodium chloride (sieved to particle sizes 250-425 μm), was place in the bottom of a confined stainless steel mold having an inner diameter of 50 mm and wall thickness of 5 mm (FIG. 1). Then the thin 70:30 PLDLa sheet was place on top of the layer of salt and then another 15 g of NaCl (250-425 μm) was layered on top of the solid polymer sheet. The plunger of the confined mold was placed on top and the materials were compressed using a 2 stage procedure. The first stage of compression was carried out at 360° F. at 1,000 pounds of pressure for 8 minutes. Next, the materials were compressed further under 10,000 pounds of force at 360° F. for 4 minutes.

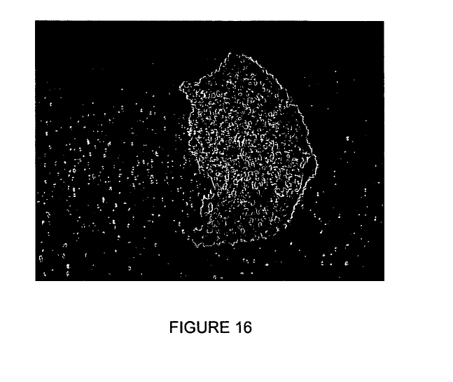

After cooling, the composite material was removed from the mold and the excess salt from the outside and inside of the polymer solid was leached away by soaking in water under agitation for 2-3 days with frequent water changes. The resulting porous scaffold sheet is shown in FIG. 16.

### Example 14

This example describes the increased expression of osteocalcin in scaffolds coated with collagen, apatite and regenerative cells. PDLGa 85:15 scaffolds were made to have a final thickness of approximately 2 mm thick using a procedure similar to the method described in Example 5. The scaffolds were subsequently argon plasma etched for 6 minutes and then prewet with 100% ethanol. After being rinsed three times in deionized water the scaffolds were hung in a 0.04 mg/ml solution of collagen type I in PBS for 24 hrs with slow magnetic stir bar agitation. The collagen coated scaffolds were then hung in a 5×SBF solution having a pH of 6.5 for 24 hours with slow magnetic stir bar agitation. Next, the scaffolds were moved to a magnesium and carbonate free 5×SBF solution having a pH of 6.0 for 24 hours with agitation. The coated scaffolds were then rinsed in deionized water and allowed to dry overnight.

Freshly isolated adipose derived cells (isolated by methods known in the art, e.g., Zuk, P. A., M. Zhu, P. Ashjian, D. A. De Ugarte, J. I. Huang, H. Mizuno, Z. C. Alfonso, J. K. Fraser, P. Benhaim and M. H. Hedrick (2002). “Human adipose tissue is a source of multipotent stem cells.” Mol Biol Cell 13(12): 4279-95) were pipetted directly onto the scaffolds in a small volume and allowed to attach for an hour prior to adding osteogenic culture medium. The cells were moved to a 37° C. tissue culture incubator and kept for 21 days with media changes every three days. The cells were then lysed and the RNA collected for quantitative reverse transcription polymerase chain reaction determination of osteogenic gene expression.

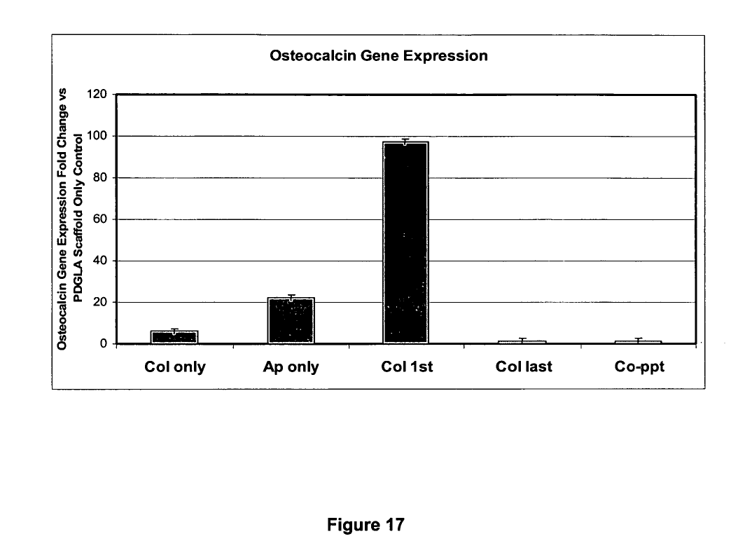

The effect of the coatings on the scaffolds on the expression of the osteocalcin gene is shown in FIG. 17. The increased expression of osteocalcin in the scaffolds coated with collagen first, and an apatite coating second, demonstrates that this coating method can promote the differentiation of the cells towards a bone phenotype.

Equivalents

Those skilled in the art will recognize, or be able to ascertain using no more than routine experimentation, many equivalents to the specific embodiments of the invention described herein. Such equivalents are intended to be encompassed by the following claims.

What is claimed is:

1. A method comprising placing one or more polymer solids between one or more layers of particles and compressing the particles into the polymer solid.

2. The method of claim 1, wherein the compression is thermal compression.

3. The method of claim 1, wherein the polymer is selected from the group comprising a polymer sheet, a polymer block, a polymer pellet and a polymer granule.

4. The method of claim 1, wherein the particles are selected from a group comprising a powder, granules, morsels and short fibers.

5. The method of claim 4, wherein the particles are substantially incompressible compared to the polymer solid.

6. The method of claim 5, wherein the particles and the polymer solid have different mechanical properties.

7. The method of claim 5, wherein the particles and the polymer have different thermal characteristics.

8. The method of claim 1, wherein the particles are comprised of an inorganic material.

9. The method of claim 1, wherein the particles are comprised of a ceramic material.

10. The method of claim 1, wherein the particles are selected from the group comprising calcium phosphates, bioglasses, silicon dioxide and salts.

11. The method of claim 10, wherein the calcium phosphates are selected from the group comprising hydroxyapatite or tricalcium phosphate.

12. The method of claim 10, wherein the salt is sodium chloride.

13. The method of claim 1, wherein the particles are comprised of a biological agent.

14. The method of claim 13, wherein the biological agent is selected from the group comprising growth factors, antibiotics, hormones and vitamins.

15. The method of claim 1, wherein, the particles comprises an organic material.

16. The method of claim 15, wherein the organic material is selected from the group consisting of a polymer or a sugar.

17. The method of claim 16, wherein the sugar has different thermal characteristics than the polymer solid.

18. The method of claim 1, wherein the polymer solid is a synthetic or natural polymer.

19. The method of claim 1, wherein the polymer solid is a resorbable thermoplastic polymer.

20. The method of claim 1, wherein the polymer solid is comprised of two or more polymers.

21. The method of claim 1, wherein the particles are partially compressed into the polymer solid.

22. The method of claim 1, wherein the particles are completely embedded into the polymer solid.

23. The method of claim 1, wherein the polymer solid is coated with an organic material

24. The method of claim 23, wherein the organic material is collagen.

25. The method of claim 1, wherein the polymer solid is coated with an inorganic material.

26. The method of claim 25, wherein the inorganic material is apatite.

27. The method of claim 1, wherein the polymer solid is coated with both an organic and inorganic material.

28. The method of claim 1, wherein the polymer solid is collagen or hyaluronic acid.

29. A method comprising
placing one or more polymer solids between one or more layers of particles;
compressing the particles into the polymer solid; and
leaching the particles using a non-organic solvent.

30. The method of claim 29, wherein a porous scaffold is created.

31. The method of claim 29, wherein the leaching comprises displacement.

32. The method of claim 29, wherein the leaching comprises dissolution.

33. The method of claim 1, wherein two different polymer types are used.

34. The method of claim 29, wherein two different polymer types are used.

35. The method of claim 1, wherein two different particle types are used.

36. The method of claim 29, where two different particle types are used.

37. The method of claim 1, wherein two different polymer types and two different particle types are used.

38. The method of claim 29, wherein two different polymer types and two different particle types are used.

39. The method of claim 1, wherein the polymer solids are placed between the particles in a multi-stacked geometrically shaped configuration.

40. The method of claim 29, wherein the polymer solids are placed between the particles in a multi-stacked geometrically shaped configuration.

41. The method of claim 1, wherein the polymer solids are placed between the particles in a biologically relevant shape.

42. The method of claim 29, wherein the polymer solids are placed between the particles in a biologically relevant shape.

43. The method of claims 30, wherein the scaffold is coated with an organic material

44. The method of claim 43, wherein the organic material is collagen.

45. The method of claim 30, wherein the scaffold is coated with an inorganic material.

46. The method of claim 45, wherein the inorganic material is apatite.

47. The method of claim 46, wherein the scaffold is coated with both an organic and inorganic material.

48. The method of claim 47, wherein the scaffold is coated first with the organic material and second with the inorganic material.

49. The method of claim 48, wherein the organic material is collagen and the inorganic material is apatite.

50. The method of claim 29, wherein the solid polymer is collagen or hyaluronic acid.

51. The method of claim 30, further comprising adding cells to the scaffold.

52. The method of claim 49, wherein the cells are adipose derived regenerative cells.
